(19) United States
(12) Patent Application Publication
(10) Pub. No.: US 2011/0032511 A1
(43) Pub. Date: Feb. 10, 2011

(54) SYSTEM AND METHOD TO MEASURE NANO-SCALE STRESS AND STRAIN IN MATERIALS

(75) Inventors: Andreas Luttge, Katy, TX (US); Firdaus Udwadia, Arcadia, CA (US); Kenneth H. Nealson, Los Angeles, CA (US); Steven D. Goodman, Redondo Beach, CA (US)

Correspondence Address: WINSTEAD PC, P.O. BOX 50784, DALLAS, TX, 75201, US

(73) Assignee: William Marsh Rice University, Houston, TX (US)

(21) Appl. No.: 12/293,373

(22) PCT Filed: Mar. 19, 2007
(86) PCT No.: PCT/US07/64310

§ 371 Date: Oct. 26, 2010

Related U.S. Application Data
(60) Provisional application No. 60/783,443, filed on Mar. 17, 2006.

(51) Int. Cl. G01L 1/24

(52) U.S. Cl. 356/35.5

(57) ABSTRACT

A system for measuring stress and strain in a sample is provided. The system includes a sample holder operable to support the sample; a stress inducing assembly operable to apply force to a selected location on the sample to deform the sample by a selected distance in a range from about 0.1 angstrom to about a millimeter; and an interferometer operable to determine a surface topography of the deformed sample at a resolution in a range from about 0.1 angstrom to about a micron.

### RELATED APPLICATIONS

This application claims the benefit of U.S. Provisional Patent Application No. 60/783,443 filed Mar. 17, 2006.

### FEDERALLY-SPONSORED RESEARCH

The present invention was made in part with support from the Office of Naval Research, Grant No. N00014-06-0115.

### FIELD OF THE INVENTION

The present invention relates in general to testing materials, and, more specifically, to measuring strain and stress at the angstrom-scale to micron-scale.

### BACKGROUND

As nano-scale and micron-scale fabrication capabilities continue to develop, an understanding the properties of a given material at the nano-scale to micron-scale becomes increasingly important. But even in macro-scale applications, it may be useful to determine the nano-scale to micron-scale behavior or properties of a material. Accordingly, many fields, including the material, earth and life sciences, as well as the semi-conductor, optical, oil and energy industries, for example, have applications that would benefit from the measurement of nano-scale or micron-scale stress and strain in materials.

Unfortunately, conventional methods of material analysis do not allow for a determination of nano-scale to micron-scale stress and strain in materials. Moreover, conventional analysis using large samples may present several disadvantages. For example, large-sample testing may not provide the desired data concerning nano-scale or micron-scale behavior. Large sample analysis is also expensive, requires extensive testing and generally difficult due to the need to control several outside forces and factors. Therefore, it is a desire to provide a system and method for measuring stress and strain at the nano-scale to micron-scale of a selected material.

### SUMMARY OF THE INVENTION

In view of the foregoing and other considerations, the present invention relates to measuring stress and strain at the angstrom-scale to micron-scale of a selected material.

Accordingly, a system for measuring stress and strain in a sample is provided. The system includes a sample holder operable to support the sample; a stress inducing assembly operable to apply force to a selected location on the sample to deform the sample by a distance in a range from about 0.1 angstrom to about a millimeter; and an interferometer operable to determine a surface topography of the deformed sample at a resolution in a range from about 0.1 angstrom to about a micron.

A method for measuring stress and strain in a sample is provided. The method includes the steps of comprising the steps of supporting the sample at a selected location on the sample; inducing stress in the sample to deform the sample by a distance in a range from about 0.1 angstrom to about a millimeter; and determining a surface topography of the deformed sample at a resolution in a range from about 0.1 angstrom to about a micron.

The foregoing has outlined the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

The foregoing and other features and aspects of the present invention will be best understood with reference to the following detailed description of a specific embodiment of the invention, when read in conjunction with the accompanying drawings, wherein:

FIG. 1 is an embodiment of the system of the present invention for measuring angstrom-scale to micron-scale strain and stress in a material;

FIG. 2 shows the positioning of an embodiment of the stress inducing assembly of the present invention;

FIG. 3 shows another positioning of the stress inducing assembly shown in FIG. 2; and

FIG. 4 is another embodiment of the stress inducing assembly of the present invention.

### DETAILED DESCRIPTION

Refer now to the drawings wherein depicted elements are not necessarily shown to scale and wherein like or similar elements are designated by the same reference numeral through the several views.

The present invention is directed to a system and method of precisely stressing a sample under selected conditions and quantifying the resulting deformations using interferometry or a similar technique at angstrom-scale, nano-scale or micron-scale resolution. For example, the present invention may allow a precise determination of strain as a function of deviation from the stress point on the sample. This precise quantification of stress and strain may provide an accurate assessment of the properties and behavior of the sample, for instance. The present invention may provide rapid, small-scale analysis with extremely high precision and resolution. Moreover, the small-scale testing of the present invention may avoid problems typically associated with testing large samples.

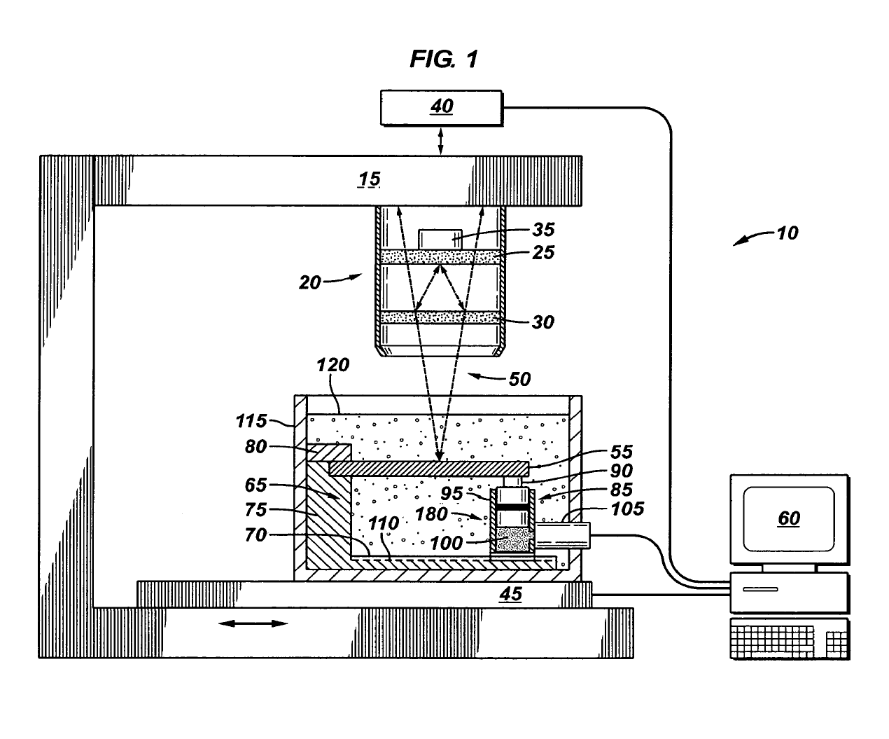

FIG. 1 shows an embodiment of the system of the present invention for measuring angstrom-scale to micron-scale stress and strain in materials, indicated generally at 10. System 10 includes interferometer 15. Interferometer 15 may be a vertical scanning interferometer (VSI), phase-shifting interferometer, Mirau interferometer, or any other analytical instrument capable of using microscopic interferometry techniques to determine the surface topography of sample 55 with micron-scale, nano-scale, angstrom-scale or sub-angstrom-scale resolution. Depending on the type of interferometer 15 used, interferometer 15 may include objective 20, reference surface 25, beam splitter 30, mirror 35, camera 40 and interferometer stage 45. Camera 40 may be a charged coupled device (CCD) camera, for example. Interferometer 15 may be connected to computer system 60 to allow computer system 60 to receive data from interferometer 15 and control interferometer 15. Computer system 60 may include surface mapping software to manage or process data from interferometer 15. Computer system 60 may be operable to control the positioning of interferometer stage 45, e.g., selectively move sample holder 65 in an X-Y direction.

An embodiment of the sample holder of the present invention is shown generally at 65. Sample holder 65 may receive specimen or sample 55 of a selected width, thickness and length. Sample 55 is preferably small, e.g., ranging from nanometer-scale to centimeter-scale. Sample 55 may comprise specimens with variable cross-sectional shapes and cross-sectional areas. Sample 55 may also comprise specimens with fractures and other material imperfections. For example, as shown in FIG. 1, sample 55 may be a small blade or bar of selected material. Sample 55 may be a sample of a selected solid material or device, including, for example, metal, mineral, ceramic, glass, microbial biofilm and other bio-material (such as bone, for example), among other materials. Sample 55 may be a micro-device, nano-device or other small device, including, for example, a semiconductor chip, piezoelectric or lead zirconium titanate (PZT) device, or other microelectronic device. If necessary, sample 55 may be treated or coated to facilitate analysis by interferometer 15, e.g., coating sample 55 to provide a reflective surface.

Sample holder 65 includes a base plate 70 to support end plate 75. End plate 75 is shaped to receive a portion of sample 55. Sample holder 65 may be fabricated from stainless steel or titanium alloy, for example. End plate 75 is preferably heat-treated or otherwise selected or fabricated to be harder than sample 55. Cap 80 secures sample 55 to end plate 75 to substantially rigidly fix sample 55 in a selected position over base plate 70. As shown in FIG. 1, sample holder 65 holds sample 55 in free suspension over base plate 70, e.g., a cantilever. Although an end plate and cap configuration is described herein, sample holder 65 may use any suitable device or configuration to secure sample 55.

End plate 75 and cap 80 may be configured to allow sample holder 65 to accommodate and position multiple samples 55. For example, sample holder 65 may accommodate multiple samples 55 of multiple types, e.g., different dimensions, different materials, etc. Sample holder 65 includes base plate track 110 to couple piston assembly 85 to sample holder 65 and allow the position of piston assembly 85 to be adjusted along the length of base plate track 110. Sample holder 65 may include multiple base plate tracks 110 to allow sample holder 65 to accommodate multiple piston assemblies 85. In this manner, sample holder 65 may allow for testing of multiple samples under varying parameters at the same time, for example.

System 10 allows a user to induce a precise amount of stress and strain in sample 55. System 10 comprises stress inducing assembly 180, which may comprise any mechanical, electrical, hydraulic, pneumatic, piezoelectric or similar device or assembly operable to deform sample 55 or otherwise induce stress and strain in sample 55. Stress inducing assembly 180 is sized and configured to allow a user to precisely deform sample 55 by a relatively small amount, and to allow fine adjustments to the amount of deformation. Accordingly, stress inducing assembly 180 is preferably operable to selectively deform sample 55 in the millimeter, micron, nanometer or even sub-angstrom range (e.g., about 0.1 angstrom), and in increments thereof. Stress inducing assembly 180 may deform sample 55 with an applied force, including tensile (pulling) forces, compressive (pushing) forces, shear, bending or torsion (twisting), for example. Stress inducing assembly 180 may be communicatively coupled to computer system 60 to allow computer system 60 to control the operation or positioning of stress inducing assembly 180. Stress inducing assembly 180 may vary force over a selected period of time, e.g., as automated by computer system 60. Stress inducing assembly 180 may include one or more devices.

For example, as shown in FIG. 1, stress inducing assembly 180 includes piston or jack assembly 85 to deform or deflect sample 55. Piston assembly 85 includes piston 90 positioned within housing 95. Piston assembly 85 includes translation device 105 that is operable to actuate piston 90 via hydraulic system 100. Translation device 105 may be any mechanical, electrical, hydraulic, pneumatic, or similar device operable to actuate piston 90. Translation device 105 may be a stepper motor or worm drive, for example. Piston assembly 85 may be connected to computer system 60 to allow computer system 60 to control the positioning of piston assembly 85 and piston 90, e.g., provide a user with computer-assisted control or allow for an automated testing process.

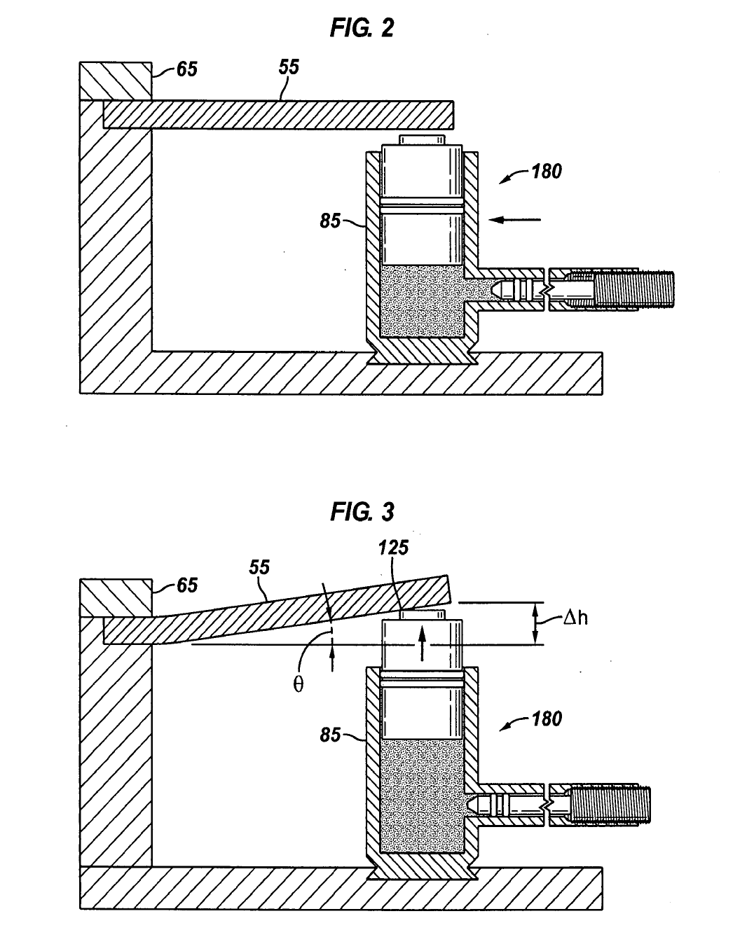

Piston assembly 85 may be positioned proximate to sample 55 at a selected location with respect to sample 55. For example, as shown in FIG. 2, piston assembly 85 may be moved along the length of sample 55. Once piston assembly 85 is in the selected position, translation device 105 may be engaged to actuate piston 90 until piston 90 engages or contacts the sample 55 at a selected contact point. As shown in FIG. 3, piston 90 engages sample 55 at contact point 125 e.g., at some selected spot along the length of sample 55. Piston 90 may then induce stress and strain in sample 55 by selectively deforming sample 55. For example, piston 90 may be actuated a selected distance Δh to apply a force to deflect or displace sample 55 at an angle θ to the horizontal. Accordingly, stress may be continuously and dynamically imposed at any point along the length of sample 55. Piston assembly 85 is designed to allow for small and precise adjustments to piston 90 to allow system 10 to induce precise and small amounts of stress and strain in sample 55. For example, system 10 may be operable to provide as little as 1 angstrom to 1 micron of deflection in sample 55, for example, e.g., shown as Δh in FIG. 3. The values for Δh and angle θ may be controlled by computer system 60, via control of the hydraulics of piston assembly 85 (or stress inducing assembly 180) by computer system 60, for example.

Once stress has been induced in sample 55, e.g., deformed by piston assembly 85, interferometer 15 analyzes or measures a selected section of sample 55. For example, as shown in FIGS. 1-3, interferometer 15 may image a selected section on the top surface of sample 55. System 10 may conduct multiple passes so that interferometer 15 may perform a topographical analysis of the entire surface of sample 55. Interferometer 15 directs a source beam (not shown) on objective 20. Part of the light 50 from the source beam falls onto the surface of sample 55. The rest of light 50 is reflected by beam splitter 30 to reference surface 25. Light 50 reflected by sample 55 and light 50 reflected by mirror 35 or reference surface 25 are combined again at beam splitter 30. These two light beams 50 interfere and the resulting interference pattern may show the difference between the surface of sample 55 and reference surface 25. Interferometer 15 is not limited to the configuration shown in FIG. 1 and other types of interferometers may be used.

Interferometer 15 provides the surface topography of sample 55 to micron, nanometer or sub-angstrom precision for a selected section of sample 55. For example, if interferometer 15 is a VSI instrument, system 10 may be capable of measuring the topography of the surface of sample 55 relative to the absolute displacement of piston 90 with sub-nanometer vertical precision and submicron lateral resolution. Because interferometer 15 quantifies the surface response of sample 55, system 10 may quantify the stress and strain of sample 55. Accordingly, system 10 may determine the relationship between stress (e.g., the internal distribution of force per unit area in response to external loads applied to sample 55) and strain (e.g., the deformation caused by the action of stress on sample 55) and the surface reactivity of sample 55 via the topographical analysis of sample 55. Furthermore, because of the resolution and precision of system 10, this relationship may be expressed in very precise terms to micron, nanometer, angstrom, or sub-angstrom precision (e.g., about 0.1 angstrom). For example, by using a narrow band of green light (e.g., centered around 550 nm, for example) interferometer 15 may provide sub-angstrom resolution (e.g., about 0.5 A). The height scan-range may be about 4 microns. By using white light, the resolution of interferometer 15 may be about 2 nm, but the height scan-range may increase to about 100 microns. The configuration of interferometer 15 may be based on sample 55 or the particular application or relationship to be analyzed, and may be changed during the testing process.

Computer 60 may include software to integrate the surface data to provide a topographical image of the entire surface of sample 55, e.g., stitch together multiple images to form a composite image. Computer system 60 may provide a 3D map of the surface of sample 55 as a function of imposed or induced stress and strain, e.g., 3D stress and strain fields. Because system 10 involves a well-defined geometry, a user may compare modeled predictions of sample behavior to the actual (and precise) measured results, for example. The spatial analysis provided by system 10 allows a user to determine several properties of sample 55 such as elasticity and brittleness, among other characteristics. The spatial analysis may be used in many different applications, including quality testing, for example.

Referring to FIG. 1, system 10 may include cell 115 operable to contain (or immerse) sample holder 65 within a selected cell environment 120. Cell environment 120 may be selected to expose sample 55 to a selected physical or chemical environment. System 10 may then provide a topographical analysis of sample 55 within these selected conditions or after sample 55 has been exposed to these conditions for a selected period of time. Accordingly, system 10 may provide an in situ study of the relationships between sample stress and strain and the selected environmental conditions. For example, cell environment 120 may include a selected fluid, gas, solution or biological matter, e.g., microorganisms. Alternatively, or in addition, cell 115 may be configured to provide cell environment 120 with a selected temperature, pressure, or atmospheric composition, for example. As a result, system 10 may also allow for testing the effects of material degradation, e.g., where cell environment 120 comprises a corrosive liquid or gas, for example. Cell 115 and cell environment 120 may be made sterile (e.g., devoid of biota) and may also be maintained such that objects added to cell environment 120, e.g., sample 55, will not cause contamination.

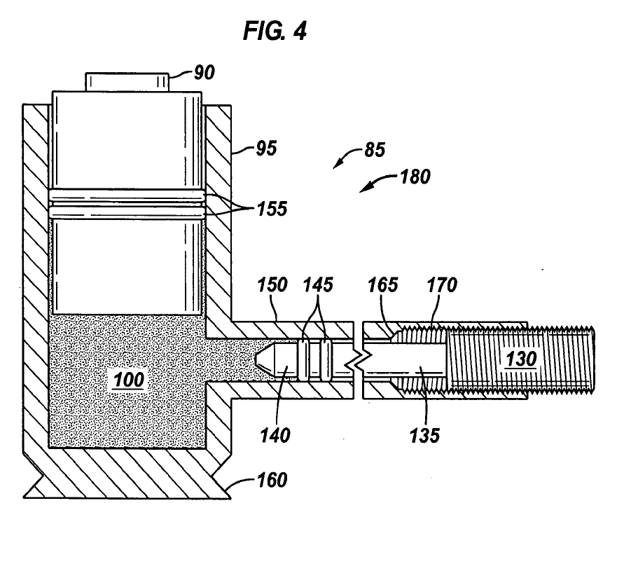

FIG. 4 shows an embodiment of piston assembly 85. Piston assembly 85 includes housing or sleeve 95 to house major piston 90 and hydraulic system 100. Hydraulic system 100 may comprise any suitable hydraulic fluid, e.g., oil, for example. Piston assembly 85 includes O-rings 145 and 155 to seal hydraulic system 100. Piston assembly 85 includes piston assembly base 160 to couple with base plate track 110 and allow piston assembly 85 to be selectively positioned along base plate track 110, e.g., coupling via a dovetail joint, for example. Piston assembly 85 includes arm 150 to house set screw or bolt 130, bolt pin 135, and minor piston 140. The interior shaft of arm 150 and bolt 130 may both be threaded such that the rotation of bolt 130 engages arm threading 170 and moves bolt 130 through arm 150. Bolt 130 may engage bolt pin 135 to push minor piston 140 into hydraulic system 100. Arm 150 may include tapered entrance 165 for non-abrasive O-ring insertion. The insertion of minor piston 140 into housing 95 displaces hydraulic fluid 100 and engages major piston 90, e.g., major piston 90 is pushed up as bolt 130 is screwed into the shaft of arm 150. The annulus provided by cylindrical housing 95 may provide a fixed reference surface, with an outside diameter slightly larger that the width of sample 55, thus allowing access by the optic path of interferometer 15 from above.

Piston assembly 85 is sized and configured to allow a user to precisely deform sample 55 by a relatively small amount, and to allow fine adjustments to the amount of deformation, e.g., deflect sample 55 by a small distance. For example, as shown in FIG. 2, piston assembly 85 may be configured or sized such that piston 90 moves 0.5 micron for every 1° of rotation of set screw or bolt 130. In this embodiment, major piston may be about 4 mm in diameter, housing 95 may be about 9 mm in diameter and 1 mm thick, and arm 150 may be about 21 mm long, for example. The precision of piston assembly 85 may be increased by increasing the surface area of major piston 90, e.g., decreasing the amount that major piston 90 is moved for the same offset in minor piston 140. In this manner, piston assembly 85 may be configured to provide 1 nanometer precision, for example.

The present invention allows for quantification of sub-angstrom, nano-scale or micron-scale stress and strain in a material. The embodiments described herein include quantifying the stress and strain produced by a piston on a sample cantilever. One of ordinary skill in the relevant arts will recognize that other configurations of sample 55 or piston assembly 85 are possible. For example, sample holder 65 may secure sample 55 at two or more points, e.g., sample 55 may be supported at both ends. As another example, piston 90 may impinge upon sample 55 from other directions, e.g., piston 90 may impinge the top or a side of sample 55.

System 10 is not limited to using a piston and stress inducing assembly 180 may include other types of devices to produce stress and strain in sample 55. For example, system 10 may include a clamp coupled to one end of sample 55 (e.g., opposite end plate 75) and operable to rotate in order to twist sample 55. System 10 may provide additional or alternative types of force to selectively induce stress and strain in sample 55, e.g., shear strain. For example, sample holder 65 may include a vise to apply compression or a clamp to apply torsion to deform sample 55. As another example, while a piston may provide compression stress at the top surface of sample 55, a movable weight attached to sample 55 may provide tensile stress to the upper surface of sample 55, with sample response measured in a similar fashion. System 10 may also impinge or direct force at multiple points on sample 55, e.g., additional pistons to push sample 55 from the side.

Similarly, system 10 may be used to investigate torsional stresses by applying the piston force offset from the centerline of sample 55 (e.g., from a plan view). As a result, warping created at selected scales (e.g., from millimeter-scale to sub-angstrom-scale) may be quantified, and the stresses and strains associated with warping and torsion may be precisely determined. For example, the offset and Δh distances used may determine the magnitude of the warping torque generated. The warping torque may be precisely measured, and the surface topography may be precisely measured to find the stress-strain levels along the centerline of sample 55 (as well as laterally). Computer system 60 may also be used to select and precisely control the offset.

Depending on the desired application, components of system 10, such as sample holder 65 and stress inducing assembly 180, may be implemented on a larger or smaller scale than specifically described herein. For instance, if sample 55 is nanometer sized, sample holder 65 may comprise an etched silicon chip (e.g., serving as the cantilever and base) with a small paizo-strip serving as the piston and piston assembly. In this manner, system 10 may deform sample 55 in the nanometer, angstrom or sub-angstrom scale (e.g., about 0.1 angstrom).

From the foregoing detailed description of specific embodiments of the invention, it should be apparent that a system and method for measuring angstrom-scale or micron-scale stress and strain in a selected material that are novel have been disclosed. Although specific embodiments of the invention have been disclosed herein in some detail, this has been done solely for the purposes of describing various features and aspects of the invention, and is not intended to be limiting with respect to the scope of the invention. It is contemplated that various substitutions, alterations, and/or modifications, including but not limited to those implementation variations which may have been suggested herein, may be made to the disclosed embodiments without departing from the spirit and scope of the invention as defined by the appended claims which follow.

What is claimed is:

1. A system for testing a sample, comprising
a sample holder operable to support the sample;
a stress inducing assembly operable to apply force to a selected location on the sample to deform the sample by a distance in a range from about 0.1 angstrom to about a millimeter; and
an interferometer operable to determine a surface topography of the deformed sample at a resolution in a range from about 0.1 angstrom to about a micron.

2. The system of claim 1, wherein the interferometer is operable to determine the surface topography of the deformed sample at a resolution in a range from about 0.5 angstrom to about a micron.

3. The system of claim 2, wherein the stress inducing assembly is operable to deform the sample by a distance in a range from about an angstrom to about a micron.

4. The system of claim 3, wherein the stress inducing assembly is operable to deform the sample by a distance in a range from about an angstrom to about a nanometer.

5. The system of claim 4, wherein the interferometer is selected from a group comprising a vertical scanning interferometer and a phase-shifting interferometer.

6. The system of claim 5, wherein the stress inducing assembly comprises a piston.

7. The system of claim 5, wherein the sample holder supports the sample at a plurality of selected locations on the sample.

8. The system of claim 5, wherein the stress inducing assembly is operable to apply force to a plurality of selected locations on the sample.

9. The system of claim 5, wherein the sample holder is operable to support a plurality of samples.

10. The system of claim 5, further comprising a cell operable to house the sample holder and the sample within a selected environment.

11. The system of claim 10, wherein the cell comprises a selected liquid or gas.

12. The system of claim 11, wherein the selected environment comprises a selected pressure or temperature.

13. A method of testing a sample, comprising the steps of:
supporting the sample;
inducing stress in the sample to deform the sample by a distance in a range from about 0.1 angstrom to about a millimeter; and
determining a surface topography of the deformed sample at a resolution in a range from about 0.1 angstrom to about a micron.

14. The method of claim 13, wherein the step of determining the surface topography further comprises the step of determining the surface topography of the deformed sample at a resolution in a range from about 0.5 angstrom to about a micron.

15. The method of claim 14, wherein the step of inducing stress in the sample further comprises the step of deforming the sample by a distance in a range from about an angstrom to about a micron.

16. The method of claim 15, wherein the step of inducing stress in the sample further comprises the step of deforming the sample by a distance in a range from about an angstrom to about a nanometer.

17. The method of claim 16, further comprising the step of selecting the distance the sample is deformed.

18. The method of claim 16, wherein the step of inducing stress in the sample further comprises the step of applying a force to a selected location on the sample.

19. The method of claim 16, wherein the step of determining a surface topography of the deformed sample further comprises the step of providing a 3D map of the surface of the sample as a function of the induced stress.

20. The method of claim 16, further comprising the step of determining a strain response of the sample to the induced stress.

21. The method of claim 16, further comprising the step of positioning the sample in a selected environment.

22. The method of claim 16, further comprising the step of determining a torsional stress-strain relationship for the sample.

23. The method of claim 16, further comprising the step of determining a warping stress-strain relationship for the sample.
